(19) United States
(12) Patent Application Publication
(10) Pub. No.: US 2025/0311787 A1
(43) Pub. Date: Oct. 9, 2025

(54) ELECTRONIC AEROSOL PROVISION SYSTEM INCLUDING A MOTION SENSOR AND AN AI-SYSTEM

(71) Applicant: NICOVENTURES TRADING LIMITED, London (GB)

(72) Inventor: Abhishek SATISH, Chennai (IN)

(21) Appl. No.: 18/864,685

(22) PCT Filed: May 5, 2023
(86) PCT No.: PCT/GB2023/051197

§ 371 Date: Nov. 11, 2024

(30) Foreign Application Priority Data
May 12, 2022 (GB) 2206940.5

(51) Int. Cl. A24F 40/50; A24F 40/65; G06F 3/0346

(52) U.S. Cl. CPC A24F 40/50; A24F 40/65; G06F 3/0346

(57) ABSTRACT

An electronic aerosol provision system including: a motion sensor configured to provide data samples relating to motion of at least a part of the electronic aerosol provision system; a filter configured to extract features from the motion sensor data samples; and an artificial intelligence (AI) system configured to receive the extracted features and to use them to identify different user inputs for the electronic aerosol provision system.

### FIELD

The present disclosure relates to an electronic aerosol provision system.

### BACKGROUND

Electronic aerosol provision systems (devices), including e-cigarettes, electronic vapour provision devices and systems, electronic aerosol/vapour/nicotine delivery devices and systems, and the like, may have a modular form. For example, such a device (system) may comprise a cartridge containing an aerosol precursor material, such as a reservoir of liquid, and a control unit containing a power source, such as a battery. When a user operates the device, such as by pressing a button or inhaling on a mouthpiece of the device, the control unit operates the battery to provide power to generate an aerosol from the aerosol precursor material. In many devices, the cartridge includes an atomizer, such as a resistive heater that generates the aerosol by vaporising a small amount of liquid (such a cartridge may be referred to as a cartomiser).

Accordingly, electronic aerosol provision systems typically incorporate two consumables, firstly a liquid or other aerosol precursor material, and secondly power in the battery. Regarding the former, once a reservoir of liquid or other aerosol precursor material has been exhausted, the cartridge may be refilled, or alternatively discarded to allow replacement with a new cartridge. Regarding the latter, an e-cigarette usually includes some form of wired or wireless (inductive) facility to receive power from an external charging facility, thereby allowing the battery to be re-charged.

Electronic aerosol provision systems are sometimes provided with more sophisticated functionality. For example, some systems may provide a user control interface to alter the level, duration and/or time profile of heating power supplied by the battery. Such alteration may help to personalise the system for a particular user (or for a particular mood of the user). Another example of a user control operation is to enter a PIN (personal identification number), which may be required to enable use of the device.

However, while it is desirable for an electronic aerosol provision system to have a user interface that supports such increasingly complex functionality, it also remains desirable to provide an electronic aerosol provision system which is compact, readily portable, robust, low in power consumption, and not too expensive. It can be difficult for the developer of an electronic aerosol provision system to reconcile these various design objectives.

### SUMMARY

The disclosure is defined in the appended claims.

An electronic aerosol provision system is provided herein, said system comprising a motion sensor configured to provide data samples relating to motion of at least a part of the electronic aerosol provision system; a filter configured to extract features from the motion sensor data samples; and an artificial intelligence (AI) system configured to receive the extracted features and to use them to identify different user inputs for the electronic aerosol provision system.

Also provided herein is a method of operating an electronic aerosol provision system, said method comprising: obtaining data samples relating to motion of at least a part of the electronic aerosol provision system from a motion sensor; filtering the data samples to extract features of the data samples; and using an artificial intelligence (AI) system to identify different user inputs for the electronic aerosol provision system from the features.

### BRIEF DESCRIPTION OF THE DRAWINGS

Various implementations of the invention will now be described in detail by way of example only with reference to the following drawings:

FIG. 1 is a high-level schematic (exploded) diagram of an electronic aerosol provision system (device).

FIG. 2 is a high-level schematic diagram of a control unit of the electronic aerosol provision system of FIG. 1.

FIG. 3 is a high-level schematic diagram of a cartomiser (cartridge) of the electronic aerosol provision system of FIG. 1.

FIG. 4 is a high-level schematic diagram of certain electrical components of the control unit of FIG. 2, including an artificial intelligence (AI) system.

FIG. 5 is a high-level schematic diagram showing an example of using the AI system in the electronic aerosol provision system of FIG. 1 to recognise and output recognised gestures.

FIG. 6 is an example data structure in the form of a table, for storing data samples corresponding to spatial motion of an electronic aerosol provision system.

FIG. 7 is an example data structure in the form of a table, for storing extracted features corresponding to spatial motion of an electronic aerosol provision system.

FIG. 8 is an example data structure in the form of a look-up table, for storing data for use by an AI system in identifying user inputs.

FIG. 9 is a high-level schematic diagram showing an example of using the AI system in the electronic aerosol provision system of FIG. 1 to recognise and output identified user inputs.

FIG. 10 is a schematic flowchart showing a process of identifying user inputs in accordance with the electronic aerosol provision system of FIG. 1.

FIG. 11 is a schematic flowchart showing a process of identifying user inputs in accordance with the electronic aerosol provision system of FIG. 1.

### DETAILED DESCRIPTION

The present disclosure relates to an electronic aerosol provision system (device). As used herein, the term “electronic aerosol provision system” refers to an aerosol provision system comprising one or more electronic components, such as a controller for controlling operations of the electronic aerosol provision system. The electronic aerosol provision system may or may not comprise its own power source (such as a battery). The controller may be configured to control any suitable operation of the aerosol provision device, including, but not limited to, delivery of at least one substance to a user. The generation of an aerosol from an aerosol-generating material may or may not be achieved through electronic means.

In some implementations, the electronic aerosol provision system is a “non-combustible” aerosol provision system. According to the present disclosure, a “non-combustible” aerosol provision system is one where a constituent aerosol-generating material of the aerosol provision system (or component thereof) is not combusted or burnt in order to facilitate delivery of the at least one substance to the user.

In some implementations, the non-combustible aerosol provision system is an electronic cigarette (e-cigarette), also known as a vaping device or electronic nicotine delivery system (END), although it is noted that the presence of nicotine in the aerosol-generating material is not a requirement.

In some implementations, the non-combustible aerosol provision system is an aerosol-generating material heating system, also known as a heat-not-burn system. An example of such a system is a tobacco heating system.

In some implementations, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some implementations, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some implementations, consumables comprising or consisting of aerosol-generating material are configured to be used with non-combustible aerosol provision devices. These consumables are sometimes referred to as articles throughout the disclosure.

In some implementations, the non-combustible aerosol provision system may comprise an exothermic power source. In some implementations, the exothermic power source comprises a carbon substrate which may be energised so as to distribute power in the form of heat to an aerosol-generating material or to a heat transfer material in proximity to the exothermic power source.

In some implementations, the non-combustible aerosol provision system may comprise an area for receiving the consumable, an aerosol generator, an aerosol generation area, a housing, a mouthpiece, a filter and/or an aerosol-modifying agent.

In some implementations, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some implementations, the electronic aerosol provision system may comprise a combustible aerosol provision system. According to the present disclosure, a “combustible” aerosol provision system is one where a constituent aerosol-generating material of the aerosol provision system (or component thereof) is combusted or burned during use in order to facilitate delivery of at least one substance to a user.

As used herein, aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some implementations, the aerosol-generating material may comprise an “amorphous solid”, which may alternatively be referred to as a “monolithic solid” (i.e. non-fibrous). In some implementations, the amorphous solid may be a dried gel. The amorphous solid is a solid material that may retain some fluid, such as liquid, within it. In some implementations, the aerosol-generating material may, for example, comprise from about 50 wt %, 60 wt % or 70 wt % of amorphous solid, to about 90 wt %, 95 wt % or 100 wt % of amorphous solid.

As appropriate, the aerosol-generating material may comprise one or more active constituents, one or more flavours, one or more aerosol-former materials, and/or one or more other functional materials. The active substance as used herein may be a physiologically active material, which is a material intended to achieve or enhance a physiological response. The active substance may, for example, be selected from nutraceuticals, nootropics, and psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some implementations, the active substance comprises nicotine. As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof. The aerosol-former material may comprise one or more constituents capable of forming an aerosol, for example glycerine or glycol. The one or more other functional materials may comprise one or more of pH regulators, colouring agents, preservatives, binders, fillers, stabilizers, and/or antioxidants.

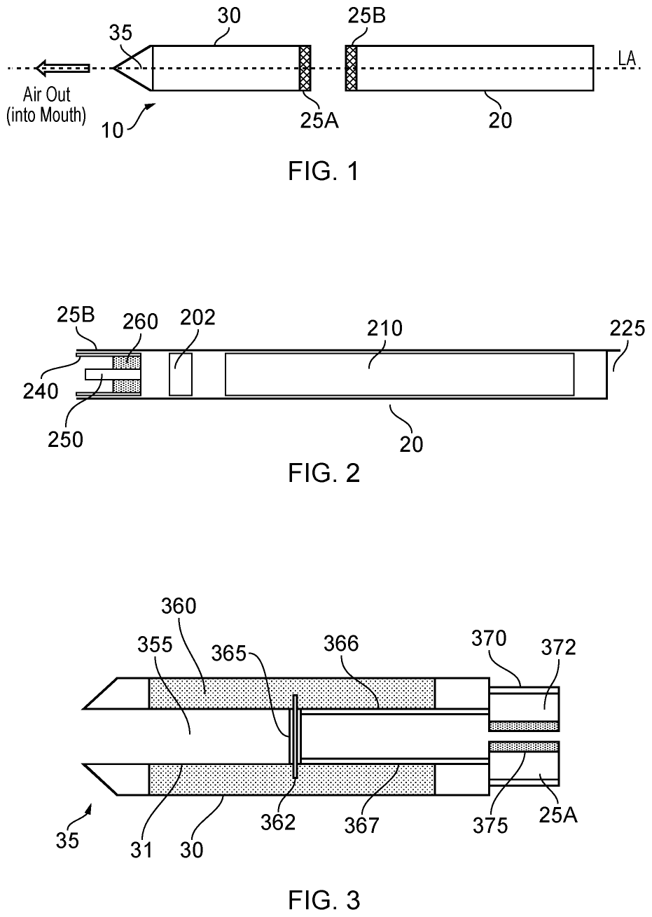

FIG. 1 is a schematic (exploded) diagram of an example of an electronic aerosol provision system. The system has a generally cylindrical shape, extending along a longitudinal axis indicated by dashed line LA, and comprises two main components, namely a control unit (body) 20, which is sometimes referred to herein as an (electronic) aerosol provision device (or, more simply, device), and which is generally a reusable component, and a cartomiser (cartridge) 30, which typically represents a consumable component. The aerosol provision device 20 and consumable 30 together form the aerosol provision device 20. The system 10 is generally compact for easy portability (e.g. in a pocket or bag) and for handheld use.

The cartomiser 30 includes an aerosol-generating material storage area, which in this example is an internal chamber containing a reservoir of liquid (where the liquid is an example of an aerosol-generating material), an aerosol generator (sometimes referred to as a vaporiser), which in the following example is a heater, and a mouthpiece 35. However, in accordance with the above, it should be appreciated that different aerosol-generating materials other than liquid may be used.

In some implementations, liquid in the reservoir typically includes nicotine in an appropriate solvent, and may include further constituents, for example to aid aerosol formation and/or for additional flavouring as discussed above. The reservoir may include a foam matrix or any other structure for retaining the liquid until it is delivered to the vaporiser, alternatively, the liquid may be held free in the reservoir. The cartomiser 30 may further include a wick or similar facility to transport a small amount of liquid from the reservoir to a heating location adjacent the heater (more generally, the wick is an example of an aerosol-generating material transfer component).

The control unit 20 normally includes at least one re-chargeable cell or battery to provide power to system 10 and at least one circuit (e.g. provided as a printed circuit board (PCB) or a flexible circuit) for generally controlling the system. When the heater receives power from the battery, as controlled by the circuit board, the heater vaporises the liquid from the wick and this vapour is then inhaled by a user through the mouthpiece 35. This use of an electronic aerosol provision system in which a user inhales an electrically generated vapour through a mouthpiece is typically referred to as vaping.

The control unit 20 and cartomiser 30 are detachable from one another by separating in a direction parallel to the longitudinal axis (LA) of the aerosol provision device 20, as shown in FIG. 1, but are joined together for use by a connection indicated schematically in FIG. 1 as 25A and 25B, which may be implemented as a bayonet or screw fitting or any other suitable form of coupling. As such, the control unit 20 may be said to comprise an area or region for receiving the consumable. This connection 25A, 25B provides mechanical and electrical connectivity between the control unit 20 and the cartomiser 30. The control unit 20 may also be provided with a facility (not shown) for connecting the control unit to an external power supply. For example, this facility may comprise a (micro/mini/type C) USB port.

The system 10 may be provided with one or more external holes (not shown in FIG. 1) for air inlet. These holes may be located in the control unit 20 and connect to an air passage through the control unit, through the connector 25A, 25B, before linking to an air path through the cartomiser 30 to the mouthpiece 35. When a user inhales on the mouthpiece 35, air is drawn into the control unit, and this airflow (or the resulting change in pressure) may be detected by a pressure sensor. In response to this detection, the system may activate the heater to vaporise the liquid received (via the wick) from the reservoir. The airflow through the vaporiser combines with the resulting vapour, and this combination of airflow and vapour passes out of the cartomiser 30 through the mouthpiece 35 to be inhaled by a user. The cartomiser 30 may be detached from the body 20 and disposed of when the supply of liquid is exhausted and replaced with another cartomiser if so desired. In some implementations, the cartomiser may alternatively (or additionally) be refillable. The liquid therefore represents an aerosol-generating material for use with device 20.

FIG. 2 is a schematic (simplified) diagram of the control unit 20 of the electronic aerosol provision system of FIG. 1, and can generally be regarded as a cross-section in a plane containing the longitudinal axis LA. As shown in FIG. 2, the control unit 20 includes a battery 210 and a printed circuit board 202 on which is mounted at least one chip, such as an application specific integrated circuit (ASIC) or microcontroller, for controlling the system 10. The PCB 202 may be positioned alongside or at one end of the battery 210. In the configuration shown in FIG. 2, the PCB is located between the battery 210 and the connector 25B. The control unit may also include an airflow and/or pressure sensor (not shown) which is used (inter alia) to detect an inhalation on mouthpiece 35. In response to such a detection of inhalation, the sensor notifies the chip on the PCB 202, which in turn initiates the flow of power from the battery 210 to a heater in the cartomiser. The control unit 20 may include one or more air inlet holes (not shown) to allow air to enter the control unit 20 and flow past the sensor when a user inhales on the mouthpiece 35, thereby enabling the sensor to detect the user inhalation.

The distal end of the control device 20 (i.e. the end opposite the mouthpiece 35 when the system 10 is in use) is denoted as the tip end 225, while at the opposite end of the control unit 20 (i.e. the proximal end closest to the user in use) is the connector 25B for joining the control unit 20 to the cartomiser 30. As noted above, the connector 25B provides mechanical and electrical connectivity between the control unit 20 and the cartomiser 30. As shown in FIG. 2, the connector 25B may include a body (control unit) connector 240, which may be metallic (or metal-coated) to serve as a first (outer) terminal for electrical connection (positive or negative) to the cartomiser 30. The connector 25B further includes an electrical contact 250 to provide a second (inner) terminal for electrical connection to the cartomiser 30 of opposite polarity to the first terminal. The body connector 240 generally has an annular or tubular shape which is aligned with the longitudinal access LA of the control unit 20 (and the overall system 10). The electrical contact 250 may be in the form of a pin located in the centre of the body connector 240, i.e. the contact 250 is aligned and coincident with the longitudinal axis LA. The body connector 240 and the electrical contact 250 are separated by an insulator 260, which is also annular in shape.

FIG. 3 is a schematic diagram of the cartomiser 30 of the system 10 of FIG. 1, and again can generally be regarded as a cross-section in a plane which includes the longitudinal axis LA. The cartomiser 30 includes an inner tube 31 which provides and encloses an air passage 355 extending along the central (longitudinal) axis of the cartomiser 30 from the mouthpiece 35 to the connector 25A for joining the cartomiser to the control unit 20. A reservoir of liquid 360 (typically including nicotine in a solvent) is provided around the air passage 355. For example, the reservoir 360 may be formed between the tube that defines the air passage 355 and the outer housing of the cartomiser 30. The reservoir 360 may comprise cotton or foam soaked in the liquid, or the liquid may be held freely in the reservoir 360 (i.e. without any such cotton or foam or other holding matrix). The liquid acts as an aerosol precursor material, as described in more detail below.

The cartomiser further includes a mechanical and electrical connector 25A to couple to the mechanical and electrical connector 25B of the control unit 20. The connector 25A has a complementary shape and structure to the connector 25B and comprises an inner electrode 375 and an outer electrode 370 that are separated by an insulator 372, all of which have an annular shape parallel to and aligned with the longitudinal axis LA. The electrical connector 25A is configured to engage and couple to the electrical connector 25B. In particular, when the cartomiser 30 is connected to the control unit 20, the inner electrode 375 contacts the electrical contact 250 of the control unit 20 to provide a first electrical path between the cartomiser and the control unit, while the outer connector 370 contacts the body connector 240 of the control unit 20 to provide a second electrical path between the cartomiser and the control unit. The inner electrode 375 and the outer electrode 370 therefore serve as positive and negative terminals (or vice versa) for receiving power by the cartomiser 30 from the battery 210 in the control unit 20.

The cartomiser 30 further includes a wick 362 and a heater 365. The wick 362, which may be made of any suitable porous material, such as cotton, glass fibre, ceramic, etc., extends from the reservoir 360 across and through the air passage 355. Likewise, the heater may be implemented in any suitable manner, for example, as a resistive heater in the form of a wire coil or metal mesh, a ceramic plate or disk, and so on. The heater 365 is electrically connected to terminals 370 and 375 via supply lines 366 and 367 to receive power from the control unit 20 (and the battery therein). The wick 362 is located close to the heater, e.g. the heater may surround or be surrounded by the wick, so that liquid transported by the wick 362 from reservoir 360 is heated by the heater 365 to generate vapour that flows along the air passage 355 and out of the mouthpiece 35 in response to a user inhaling on the electronic aerosol provision device 20.

Note that various components and details have been omitted from FIGS. 2 and 3 for reasons of clarity. For example, detailed wiring is generally not shown, such as between the connector 25B, the circuit board 202, and the battery 210, and likewise for the wiring between the power lines 366, 367 and the contact 25A. Similarly, input/output facilities (such as buttons or LEDs) for the system 10 are not shown.

It will also be appreciated that the configuration of the electronic aerosol provision device 20 shown in FIGS. 1-3 is by way of example only to provide an illustrative context for the present application. The skilled person will be aware of many potential variations, for example, rather than being a two-part system (control unit 20 and cartomiser/cartridge 30), the system 10 may be formed as a one-piece device, or alternatively may be formed from three or more sections. The aerosol-generating material may comprise a solid rather than a liquid, potentially in leaf or powdered form (or a gel or paste, etc.) as described above. In some implementations, the system may initially generate a stream of heated vapour (e.g. steam) that passes through and therefore heats the aerosol-generating material to generate the aerosol. In some implementations, the system 10 may comprise multiple different aerosol-generating materials and support making combinations or selections of such materials. Some devices may include a removable cartridge containing the reservoir 360, but the atomiser (such as heater 365) may not be included in this cartridge (e.g. the atomiser may be in a separate component). In addition, rather than having the control unit 20 extend distally from the cartomiser to provide a linear airflow along the axis LA, other implementations might have a folded arrangement. Moreover, the heater 365 may be implemented in various forms, for example, as a planar mesh or as a ceramic heater. In some cases, the atomizer may be provided as some form of nebulizer, e.g. based on vibration rather than heating. The skilled person will appreciate that these examples are just a small subset of the possible variations in configuration for an electronic aerosol provision system as disclosed herein.

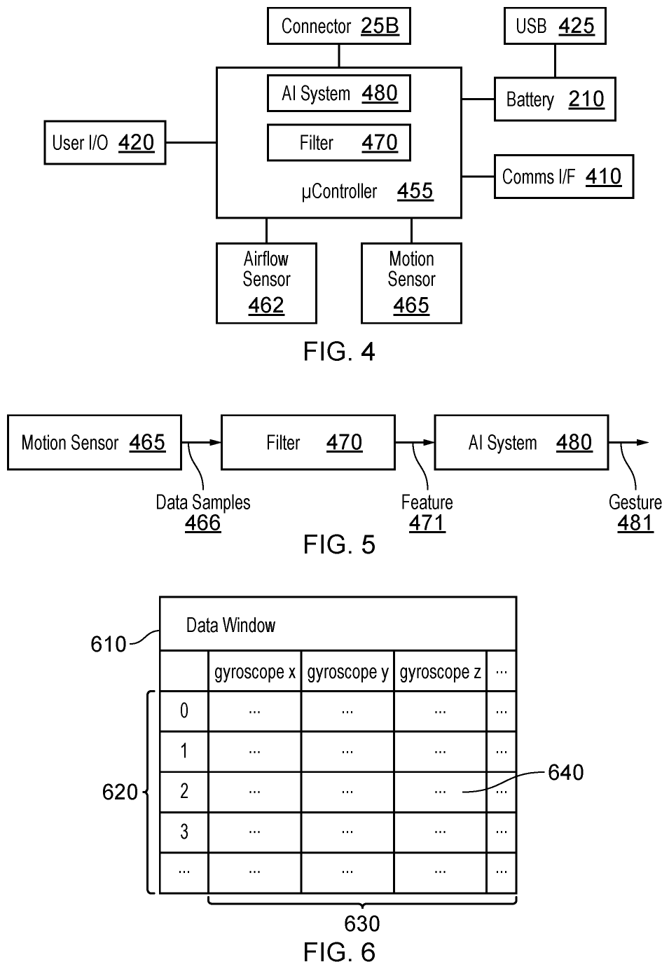

FIG. 4 is a schematic diagram of certain electrical (including electronic) components of the control unit (aerosol provision device) 20 of FIG. 1. Note that at least some of these components are shown by way of example only and may be omitted (and/or supplemented or replaced by other components) according to the circumstances of any given implementation. Furthermore, although the components shown in FIG. 4 are assumed to be located in the control unit 20 rather than in the cartomiser 30 (since a given control unit may be re-used with many different cartomisers 30), other configurations may be adopted as desired. In addition, the components shown in FIG. 4 may be located on one circuit board 202, but other configurations may be adopted as desired, e.g. components may be distributed across multiple circuit boards, or may not (all) be mounted on circuit boards. Furthermore, for clarity FIG. 4 omits various elements which are commonly present in this type of device, such as most power lines, memory (RAM) and/or (non-volatile) storage (ROM) and so on.

FIG. 4 includes a (re-chargeable) battery 210 and a connector 25B for coupling to a cartomiser (cartridge) 30, as discussed above, and a (micro) controller 455, as discussed below. The battery 210 is further linked to a USB connector 425, e.g. a micro or mini or type C connector, which can be used to re-charge the battery 210 from an external power supply (typically via some re-charging circuit, not shown in FIG. 4). Note that other forms of re-charging may be supported for battery 210—for example, by charging through some other form of connector, by wireless charging (e.g. induction), by charging through connector 25B, and/or by removing the battery 210 from the e-cigarette 10.

The device of FIG. 4 further includes a communications interface 410 which can be used for wired and/or wireless communications with one or more external systems (not shown in FIG. 4), such as a smartphone, laptop and/or other form of computer and/or other appliance. The wireless communications may be performed using (for example) Bluetooth and/or any other suitable wireless communications standard. It will be appreciated that USB interface 425 may also be used to provide a wired communications link instead of (or in addition to) the communications interface 410; for example, the USB interface 425 might be used to provide the system with wired communications while the communications interface 410 might be used to provide the system with wireless communications.

Communications to and/or from the electronic aerosol provision device 20 may be used for a wide variety of purposes, such as to collect and report (upload) operational data from the system 10, e.g. regarding usage levels, settings, any error conditions, and/or to download updated control programs, configuration data, and so on. Such communications may also be used to support interaction between the electronic aerosol provision device 20 and an external system such as a smartphone belonging to the user of the electronic aerosol provision device 20. This interaction may support a wide variety of applications (apps), including collaborative or social media based apps.

The device of FIG. 4 further includes a motion sensor 465 (as discussed below), and an airflow sensor 462 to detect when a user has inhaled on the system 10. Such a detection may trigger a supply of power by the microcontroller 455 from the battery 210 to the cartomiser 30 (in particular to heater 365) to produce a vapour output for inhalation by the user (this process is generally referred to as puff-activation). The sensor 462 may detect airflow via any suitable mechanism, such as by monitoring for a flow of air and/or a change in pressure. Note that some systems 10 do not support puff actuation; these systems are typically activated by a user pressing on a button (or some other form of direct input). The microcontroller 455 may specify (and implement) one or more heating profiles for use with heater 365; such a profile determines the variation with time in the level of power that is supplied to heater 365. For example, the microcontroller may supply most power to the heater 365 from the battery 210 at the start of a puff in order to rapidly warm the heater 365 to its operating temperature, after which the microcontroller may supply a reduced level of power to the heater 365 sufficient to maintain this operating temperature.

The device of FIG. 4 may further include user I/O functionality 420 to support direct user input into the system 10 (this user input/output may be provided instead of, or more commonly in addition to, the communications functionality discussed above). The user output may be provided as one or more of visual, audio, and/or haptic output (feedback). For example, visual output may be implemented by one or more light emitting diodes (LEDs) or any other form of lighting, and/or by a screen or other display-such as a liquid crystal display (LCD), which can provide more complex forms of output. The user input may be provided by any suitable facility, for example, by providing one or more buttons or switches on the system 10 and/or a touch screen (which supports both user input and output). As described below, user input may also be performed by movement of the device 20 (or of the whole system 10), such movement being detected using the motion sensor 465. In this case, the motion sensor 465 can be considered as part of the user input/output facility 420.

The microcontroller 455 may be located on PCB 202, which may also be used for mounting other components as appropriate, e.g. the motion sensor 465 and/or the communications interface 410. Some components may be separately mounted, such as the airflow sensor 462, which may be located adjacent the airflow path through the system 10, and a user input facility (e.g. buttons) which may be located on the external housing of the system 10. The microcontroller 455 generally includes a processor (or other processing facility) and memory (ROM and/or RAM). The operations of the microcontroller 455 (and some other electronic components), are typically controlled at least in part by software programs running on the processor in the controller (or other electronic components as appropriate). Such software programs may be stored in a non-volatile memory which can be integrated into the microcontroller 455 itself, or provided as a separate component (e.g. on PCB 202). The processor may access ROM or any other appropriate store to load individual software programs for execution as and when required. The microcontroller 455 also contains suitable interfaces (and control software) for interacting with the other components of system 10 (such as shown in FIG. 4). In addition, the microcontroller 455 supports a filter 470 and an artificial intelligence (AI) system 480, shown schematically in FIG. 4, and described in more detail below.

The configuration shown in FIG. 4 may be varied as appropriate by the skilled person. For example, the functionality of the (micro) controller 455 may be distributed across one or more components which act in combination as a microcontroller. Furthermore, in some examples, the filter 470 may be supported by the motion sensor 465 rather than the microcontroller 455 (dependent on the capabilities of the motion sensor 465). Alternatively, in some examples (not shown) the filter 470 and/or the AI system 480 may be supported by an external computing device configured to communicate with the microcontroller 455 (e.g. via interface 410).

In addition, there may be a PCB or similar provided in combination with battery 210 to control re-charging of the battery, such as to detect and prevent voltage or current overload and/or overly long charging times, and likewise to control discharging of the battery, e.g. so that the battery does not get excessively discharged to the point of damage. It will be appreciated that the above set of alternatives and variations on the configurations of FIGS. 1-4 is by no means exhaustive, and many further alternatives and variations will be apparent to the skilled person.

A motion sensor 465 provides sensitivity to motion of the system 10. In some examples, the motion sensor 465 is provided by an accelerometer or a gyroscope. In some examples, a motion sensor 465 is provided by a device, module or unit providing functionality sensitive to multiple types of movement. For example, the motion sensor 465 may be provided by, or otherwise combine, an accelerometer and a gyroscope, as well as any other component sensitive to motion of the system 10. Such a device, module or unit can be termed an inertial motion unit (or alternatively, an inertial measurement unit) instead of a motion sensor.

In some implementations, the motion sensor 465 is provided by a module LSM6DSLTR which is commercially available from STMicroelectronics and is used as a combined accelerometer and gyroscope (in effect, a 2-in-1 system-in-package chip). In particular, this device provides a 3D digital gyroscope and a 3D digital accelerometer—i.e. 3-axis sensitivity for both rotational and linear motion respectively. Further details of this module are available at: https://www.st.com/content/st_com/en/products/mems-and-sensors/inemo-inertial-modules/lsm6dsl.html.

Note that the power consumption of the LSM6DSLTR device is of the order of 0.5 mA for an “always on” configuration. If we assume a typical capacity of 500 mA hours for battery 210, the power consumption of the motion sensor 465 per day represents 2.4% of the battery capacity. This level of power consumption for motion sensor 465 can be readily supported, given that e-cigarettes are often re-charged on a daily basis (the vaporisation of the liquid generally requires a relatively high current level).

In some implementations, the microcontroller 455 is provided by a STM32F429ZIT6 module which is commercially available from STMicroelectronics and incorporates an ARM Cortex-M4 core with a digital signal processor, floating point unit and flash memory. The module includes timers for pulse width modulation (PWM), which is typically used in e-cigarettes to vary the output from a heater 365, for example, in line with heating profile as mentioned above. In particular, the duty cycle of the PWM may be decreased to supply a reduced amount of power to the heater, or raised to increase the power level. Further details are available at: https://www.st.com/content/st_com/en/products/microcontrollers-microprocessors/stm32-32-bit-arm-cortex-mcus/stm32-high-performance-mcus/stm32f4-series/stm32f429-439/stm32f429zi.html

As described herein, the motion sensor 465, the filter 470 and the AI system 480 are used in combination to identify different user inputs or gestures for the electronic aerosol provision device 20. The combination allows for an efficient approach to gesture recognition. As described herein, embedding a motion sensor 465 into an electronic aerosol provision device 20, e.g. onto a circuit board of such a device, allows for the AI system 480 to be trained and deployed to recognise consumer gestures (based on the motion data from the motion sensor 465) to complement or even fully replace mechanical operations. Advantageously the use of a filter 470 to generate features from the motion data, substantially reduces the amount of data to be processed by the AI system thereby allowing for faster processing and gesture identification by the AI system.

FIG. 5 illustrates a high level overview of the process to identify user gestures; in which the motion sensor 465 produces data samples 466 (e.g. measurements or readings by the motion sensor) representing spatial motion of the electronic aerosol provision device 20 which are passed to the filter 470. The data samples relating to motion of the device 10 provide a time series indicating at least one of the position, velocity and/or acceleration of the device 10.

The data samples 466 can be passed to the filter 470 as each measurement is recorded by the motion sensor 465, or as part of a batch of data samples after a set period of time or number of measurements, or in response to a stimulus such as a signal to the motion sensor (e.g. in response to a user pressing or ceasing to press a button). As such, it will be appreciated that the motion sensor 465 may comprise memory and processing capability to enable the storage and transmission of the data samples 466.

The data samples 466 can be passed to the filter 470 by providing them as inputs directly to the filter 470, or by placing them in a memory accessible or readable by the filter 470. For example the memory may be memory of the filter 470, or memory of the controller 455 that is accessible (e.g. allowing storage of data and reading of stored data) by both the filter 470 and motion sensor 465.

In some examples, the filter is included as part of the output of the motion sensor, as part of the input of the AI system, and/or as an intermediate component between the motion sensor and the AI system. For example, the filter 470 may be implemented by a hardware component, or a software element of the microcontroller 455. As such, the filter 470 can be supported by the controller 455 of the electronic aerosol provision device 20. In some examples the filter 470 may be implemented by a hardware component, or a software element of the motion sensor 465 (not shown). As such, the filter 470 can be supported by the motion sensor 460. In some examples, the filter 470 may be implemented by a hardware component, or a software element of an external computing device (e.g. a smartphone; not shown) in communication with the motion sensor 465 via the communication interface 410. As such, the filter 470 can be supported by an external computing device.

Based on the received data samples 466, the filter 470 then extracts (e.g. determines or calculates) one or more features 471 (i.e. one or more values of statistical and/or mathematical characteristics of the data samples received) which are then passed to the AI system 480. As such the AI system 480 can be considered to receives the data samples in the form of the extracted features. As described below, each feature 471 provides a value relating to, or otherwise dependent on, the spatial motion of the electronic aerosol provision device 20. The filter 470 may operate in the time and/or frequency domain. By a filter it is meant a component configured to extract one or more features (e.g. values of statistical and/or mathematical characteristics) from data samples stored in memory (e.g. stored in a table as exemplified by FIG. 6).

A feature may be a singular value or a set of related values. For example, a feature may be (or may be derived from) a mean, median, maximum, minimum, or correlation associated with all or part of the data samples stored in memory. It will be appreciated that mean, median, maximum, minimum, and correlations are well known statistical and/or mathematical characteristics). The features may be derived from a portion of the data samples 466. For example, a calculation (e.g. a mean) may be performed on data samples 466 corresponding to one degree of freedom. Alternatively, a calculation may be performed on data samples 466 corresponding to one degree of freedom in a first timer period (e.g. a first half of the measured window), while further calculations may be performed on the same degree of freedom but over a different time period (e.g. a subsequent or overlapping time period). In some examples, features may be calculated based on a portion of the data sample corresponding to multiple degrees of freedom. For example, values relating to the total movement of the device 20 could be calculated based on degrees of freedom relating to x, y and z motion of the device.

Furthermore, in some examples, extracted features may be used to influence the values of other features to be extracted. For example, latter features can be derived using techniques such as dynamic time warping to account for variation in gesture performance. The use of dynamic time warping may require an initial feature extraction to determine the speed at which a user is performing a gesture. By using dynamic time warping, the speed at which a user performs a gesture can be adjusted for, when determining the values of features.

It will be appreciated that the extracted one or more features of the data sample 466 have a reduced size (e.g. memory storage requirement) in comparison to the data samples 466 from which they were extracted by the filter 470. The number of features determined based on data samples can be selected on the basis of various operating parameters: available compute power on the target compute device, the similarity of the gestures performed, the number of gestures. In some examples the filter will be configured to extract the same features for each set of data samples. However, in some examples the filter may be configured to only extract certain features dependent on the data samples. For example, if the number of data samples is below a certain number, then certain features will not be calculated if it is considered that those features are not reliable for reduced sample sizes.

The AI system 480 uses the extracted features to identify or predict the gesture 481 (e.g. the user input) relating to the spatial motion of the electronic aerosol provision device 20 represented by the data samples 466. The AI system 480 therefore can be considered to act as a classifier, in that certain features (e.g. the one or more values of statistical and/or mathematical characteristics of the data samples) are considered to represent, denote or be associated with a particular gesture of a set of gestures (i.e. movement patterns corresponding to user inputs) known to the AI system 480. The AI system 480 outputs the identified gesture, thereby allowing further actions (e.g. further processes) to be taken by the control software of the electronic aerosol provision system (or a different electronic device) based on the particular gesture identified, if required. It will be appreciated that in some examples the AI system 480 may determine that the extracted features do not adequately correspond to any gesture of the set of gestures (e.g. relationships or correlations between the extracted features and each individual gesture may be below a threshold). For example it will be appreciated that an electronic aerosol provision system may undergo movement, for example, when being carried in a pocket or bag. Such movement is not intended to cause a gesture to be recognised by the AI system 480.

FIG. 6 depicts an example data structure for storing the data samples 466 corresponding to measurements or readings taken by sensing components of the motion sensor 465, where the data structure is in the form of a table 610. The data samples 466 record or detail spatial motion of the electronic aerosol provision device 20. It will be appreciated that there are various alternative data structures known to the skilled person that could be used to store the data samples (e.g. matrices). In some examples, the table 610 and the relevant data samples 466, can be stored in a buffer maintained in the electronic aerosol provision system's memory (e.g. memory associated with the microcontroller 455). Alternatively, or additionally, the table, and the relevant data samples, can be stored in a buffer maintained in memory of an external device in communication with the electronic aerosol provision system (in some examples, an external device can comprise a copy of the data stored on the electronic aerosol provision system). The memory may be memory of the filter 470, or memory of the controller 455, and is accessible (e.g. allowing storage of data and/or reading of stored data) by both the filter 470 and motion sensor 465.

Example tables have a window size or length 620 (i.e. the number of data rows) corresponding to a number of data readings, frames or samples stored in the table, and a width 630 (i.e. the number of data columns) that matches the number of axes or degrees of freedom being sampled (e.g. a 3D accelerometer has a width of 3, while a motion sensor combining a 3D accelerometer with a 3D gyroscope has a width of 6). The window size 620 indicates the number of samples to look at from the motion sensor to predict a gesture, and the width 630 indicates the number of degrees of freedom to predict a gesture. As shown the table of FIG. 6 has at least three columns, with the three columns shown corresponding to different axes (x, y, z) of a gyroscope. Furthermore, the table of FIG. 6 has a window size 620 of at least three. Each entry 650 in the table corresponds to a data sample 466 for a particular sampled degree of freedom. The particular nature and format of the data samples 466 passed from the motion sensor 465 to the filter 470 will depend on the particular implementation and situation. For example for a 6-axis motion sensor, the data samples 466 in a first set of columns of the table correspond to a time sequence of values represent linear acceleration (e.g. \ddot{x}, ÿ, \ddot{z}) while a second set of columns of values represent the change in angle or orientation of the device (e.g. Δø1, Δø2, Δø3).

In some examples the window size 620 is fixed. For example the window size 620 may be fixed such that it corresponds to the number of measurements that would be taken (i.e. the sample number) within a duration of a gesture. For example, if a user takes at most three seconds to perform gestures, then the window size 620 may correspond to three seconds multiplied by the sampling rate (i.e. the number of measurements per second). For example, if the motion sensor 465 has a sampling rate of 1 kHz, then the window size 620 would be 3000. It will be appreciated that the window size 620 is dependent on the sampling rate and the duration of the measurement period. The sampling rate for the motion data and the duration of the measurement period are sufficient to provide an accurate indication of the motion of the device

It will be appreciated that in some examples the sampling rate for different aspects of the motion sensor 465 may differ. For example, a gyroscope of the motion sensor 465 may have a sampling rate of 0.5 kHz, while an accelerometer of the motion sensor 465 may have a sampling rate of 1 kHz (or vice versa). Hence for a table 610 having a particular duration, the number of data samples in the columns 630 for the axes of the gyroscope will be half the number of data samples in the columns for the axes of the accelerometer. In other words, it is not necessary for each axes of the table to have an equivalent number of rows 620 (or if the number of rows are equivalent, then some rows of columns corresponding to measurement devices having a lower sampling rate will be empty).

In some examples, new data samples (for each axis) are added every 1/(sampling rate) seconds. In some examples, the table 610 may initially be empty, with new data samples being incrementally added to the table 610. In some examples, no new data samples are added to the table 610 once a column of the table 610 has been filled. In these examples when the number of entries 630 in a column is equivalent to the window size 620, the contents of the table 610 are used to extract the features. For example, when the data samples 466 fill the table, the filter 470 extracts the features and provides them to the AI system 480 for analysis by the AI system 480 which determines a corresponding gesture that has been performed by the user (or that no recognised gesture was performed).

In some examples, new data samples may be added incrementally to a column of the table to replace data samples contained within the column of the table 610, after the column of the table has been filled. For example, a new data sample will replace the oldest data sample in the column of the table (i.e. a moving window). In these examples, new data samples may be added up until the AI system 480 identifies a gesture from features extracted from the data samples in the table 610 (where the AI system is provided with the data samples continuously or periodically). In effect, this slides the window represented by the data samples 466 along by a portion of the window duration. New data samples 480 can then be iteratively added (either singularly or in batches) with the filter continually extracting features with each addition, and the AI system 480 re-evaluating the features. In this way the filter may be considered to extract features at a specific extraction or data rate. The rate may be termed the amount of data that is produced per unit of time, which is dependent on the how often a feature is calculated and the size of the feature in memory. The rate is typically significantly less than the sampling rate because multiple data samples are typically measured for each feature calculation. For example if data samples recorded at 1 KHz and spanning a second are used to create a single feature every second having a size equivalent to a single data sample, then the feature extraction rate is 1000×less than the data sampling rate.

In some examples, new data samples may be added up until a determination has been made that the electronic aerosol provision device 10 has not moved for a period of time. For example, in some implementations, the motion sensor 465 is able to discriminate between periods of motion and periods of no motion—the latter being determined if the values of the data samples have little or no variation. In these implementations the motion sensor 465 may incorporate functionality (e.g. processing capability) enabling the motion sensor 465 to perform analysis. In other examples, new data samples may be added to the table 610 up until a user indicates that they have stopped gesturing (e.g. by pressing or ceasing to press a button).

The duration of the measurement period (i.e. the number of rows in the example table of FIG. 6) may be set based on the reasonable maximum duration taken to perform any gesture of the set of gestures. For example, different gestures may take different durations or time periods to perform (e.g. tracing a circle with the electronic aerosol provision device 20 may take a user longer than moving the electronic aerosol provision device 20 upwards in a vertical line). Hence to allow the identification of gestures based on the stored data samples, the data samples should cover a duration in which any gesture can be distinguished from any other gesture. As stated above, in some examples, this may require the duration of the measurement period to be set based on the reasonable maximum duration taken to perform any gesture of the set of gestures. Of course, in some examples, it may be that a particular gesture is discernable from measurements within a shorter time period than it takes to perform the whole gesture, if the particular gesture can be distinguished from the measurements in the shorter time period (e.g. a user may trace a circle to provide a user input, but the window size may contain data corresponding to the spatial motion of only a portion of an arc of that circle, as long as the arc enables the circle gesture to be identified). In some examples, the duration of the measurement period may be less than 5 seconds, preferably less than 3 seconds, and more preferably less than 2 seconds.

In some examples, data samples 466 may be recorded in a table 610 (e.g. incrementally added into the table) as long as a criteria is fulfilled. In some of these examples the window size 620 may vary such that the duration of the measurement period is dependent on the length of time the criteria is fulfilled. In some examples, the criteria may be that the user is interacting with the electronic aerosol provision device to indicate that they are gesturing (for example by interacting with a user input facility, such as a button which is pressed when the user is gesturing). In some of these examples the user may indicate both the start and the end of their gesture. As such, the device 20 may be configured to allow a user to indicate the start and/or end of a gesture; for example, by pressing a button on the device 20, or by tapping the device 20. In some examples, the motion sensor 465 may respond to signal to stop transmitting or to a detection of a period of no motion by stopping the transmission of data samples 466 from the motion sensor to the filter 470 or memory accessible by the filter. As such, the motion sensor may be turned off, so no data samples are produced. In some of these examples, the table 610 may be emptied prior to new data samples being added.

In some implementations the device may operate in a number of different states. By a state of the device 20, it is meant a state or mode of operation (e.g. how the device is configured to operate) and may comprise a state or mode of operation of the microcontroller 455 which implements the filter 470, the AI system 480 and/or other components of the device. For example the first state can correspond to the device being in a dormant state (e.g. low power state) and the second state corresponds to the device being in an active state. Alternatively, the first state is in operation when a user is not controlling or interacting with the device 20 (e.g. via a user input facility such as a button), and the second state is in operation when a user is controlling or interacting with the device 20. In some examples, the system may control when the AI system is used or operated to identify a user input based on whether the device is in the first or second state (e.g. allowing the user to control the device where the AI system is operating via a user input facility that switches the device between the states). Furthermore, when the AI system 480 is not used to identify the different user inputs, either the motion sensor may be turned off, so no data samples are produced, or data samples are produced but are not provided to the AI system 480.

During this first state, the sample measurement rate (i.e. data rate) of the motion sensor 465 may be lowered or stopped, and the filter 470 may extract features less frequently if at all (for example to conserve power). For example, no features 471 may be extracted by the filter 470 from data samples recorded while the device is in the first state (e.g. the filter may be deactivated). Feature extraction may start once the microcontroller 10 or device 20 switches to the second state, thereby activating the filter. In some examples, the filter may extract features based on data samples 466 including measurements made prior to the device switching to the second state, whereas in other examples the filter 470 may extract features based on data samples 466 consisting of measurements taken only after the device switched to the second state. For example, the table 610 (or other data structure) may be emptied between the first and second states, while in other examples the table 610 is continually updated with new values such that the new values obtained while the device is in the second state will eventually push out the values taken while the device 20 was in the first state (unless data sampling is interrupted).

In some examples, the filter 470 is not deactivated during the first state and instead the filter is configured such that a first set of one or more features is extracted from the data samples in a first state of the device 20 and a second, different set of one or more features is extracted from the data samples in a second state of the device 20. In some of these examples, when the device switches from the first state to the second state, the sample rate of the motion sensor 465 and the rate at which the filter 470 extract features 471 can be increased (e.g. the filter can extract features more often).

As such, it will be appreciated that in some examples the first state is a state in which the AI system is not used to identify the different user inputs (e.g. the AI system 480, filter 470 or the controller 455 implementing the AI system is in an inactive mode), whereas the second state is a state in which the AI system is used to identify the different user inputs (e.g. the AI system 480, filter 470, the controller 455 implementing the AI system is in an active mode). As such the AI system 480 or the controller 455 implementing the AI system 480 can be switched to or placed in an active mode to enable the identification of gestures, when the device 20 switches from the first state to the second state.

It will be appreciated that in some of these examples the motion sensor 465 is configured to provide data samples relating to motion of the system directly to the AI system 480, rather than the AI system 480 receiving them via a filter which extracts features from the data samples. In other words, in some example systems the filter may be absent, and the AI system receives unfiltered data samples. The AI system 480 in these examples is configured to receive the unfiltered data samples from the motion sensor (e.g. by the motion sensor inputting them in a memory accessible by the AI system) and to use them to identify different user inputs for the system. As detailed above, in some examples the AI system may employ a plurality of AI models to identify the user input (i.e. gesture), with each AI model being trained or configured with respect to a specific user input. Furthermore, a user input facility can be provided (e.g. a button or slide) which is configured to control when the AI system is used to identify the different user inputs. This can reduce the load on any processors associated with the AI system 480, by only using said processors to employ the AI system 480 to identify gestures, when the user controls the device 20 using the user input facility to do so.

In some examples, the device 20 is configured to switch between states in response to a user interacting with a user input facility (e.g. a button). Hence, in these examples a user input facility is used by the user to control when the AI system is used to identify the different user inputs (i.e. gestures). This can be used to allow motions to only be processed when desired by a user, which can prevent accidental activation and also reduce energy consumption. In other examples, the device 20 is configured to switch between states in response to a determination that the device 20 has been moved. In these later examples the device may be configured in the first state to detect or otherwise determine that the device 20 has or is being moved. Similarly, this can be used to reduce energy consumption by only enabling certain processing function after a period of motion.

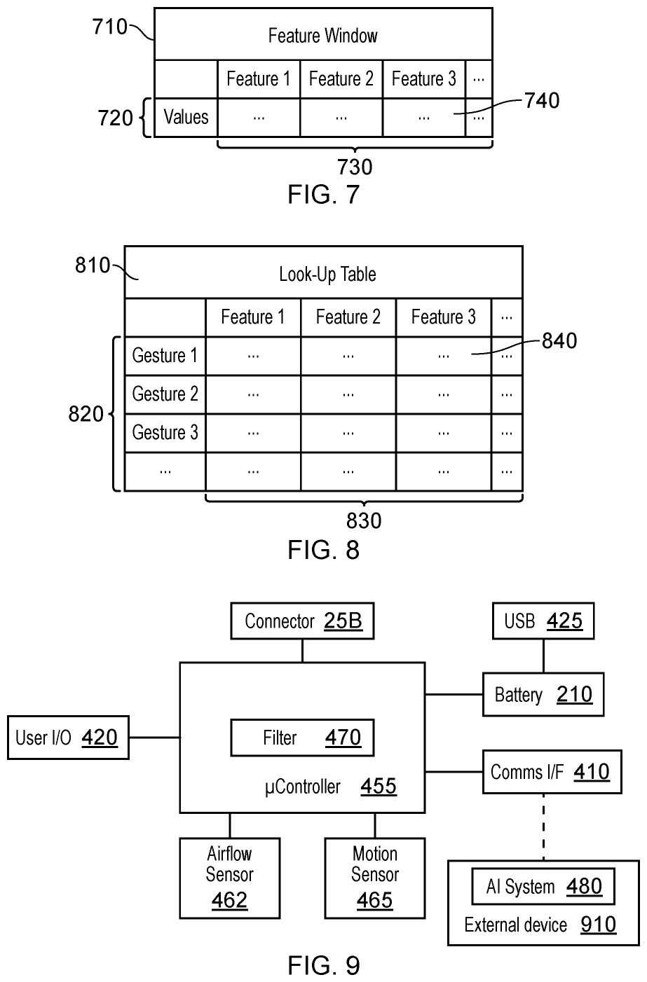

FIG. 7 depicts an example data structure for containing values of features, where the example data structure is in the form of a table 710. It will be appreciated that there are various alternative data structures known to the skilled person that could be used to store the data samples (e.g. matrices). As previously stated the features 730 (each of which has a corresponding column as shown in FIG. 7) can be values 720 or set of values. For example, a feature 740 of the features 730 may be (or may be derived from) a mean, median, maximum, minimum, or correlation associated with all or part of the data samples 466 stored in memory accessible to the filter 470. Furthermore, the features 730 may be derived or calculated using techniques such as dynamic time warping to account for variation in gesture performance. It will be appreciated that the extracted one or more features 730 of the data sample 466 have a reduced size (e.g. memory storage requirement) in comparison to the data samples 466 from which they were extracted by the filter 470. In other words, the memory required to store a value (i.e. feature 740) such as a mean of a sequence of numbers is significantly less than the memory required to store the sequence of numbers. As such, the extracted features 740 typically can be considered to have a data rate lower than the data rate of the data samples provided by the motion sensor given that they are produced less frequently than the data samples.

The number of features 730 determined or extracted based on the data samples can be selected on the basis of various operating parameter associated with the electronic aerosol provision device 20, and/or any separate device in communication with the aerosol provision device 20 through the communication interface 410. For example, the selection can be based on factors or parameters such as the available compute power, the similarity of the gestures performed, the number of gestures, and the number of measured degrees of freedom. For example, in systems having greater compute power, the number of features to be calculated may be higher, which may improve the reliability and accuracy of the gesture identification. In some example systems where there are two or more similar gestures that can be performed a larger number of features may be required to accurately differentiate between those features. Similarly, where there are more gestures in general, a larger number of features may be required to accurately differentiate between those features, in comparison to a system configured to recognise fewer gestures. Additionally, the presence of more sophisticated measurements devices providing a greater number of measured degrees of freedom, enables the measurement of an increased number of features, thereby improving accuracy and reliability.

FIG. 8 depicts an example data structure in the form of a look-up table 810 that is associated with the AI system 480, and that contains values for use in identifying a gesture associated with the extracted features 730. For example the values 840 may be reference values for comparison with the extracted features 730. As shown, the table 810 can include a number of rows that correspond to different gestures 820. Each row contains a series of values 840 corresponding to a respective gesture. As, also shown the table 810 can include a number of columns 830 that correspond to different features, each of the gestures 820 having a value 840 for each column 830 (i.e. feature). The values for each gesture stored in the look-up table 810 are used by the AI system 480 in the determination or identification of a respective gesture corresponding to the features 730 extracted by the filter 470. Each row 820 of the look-up table 810 can be considered to represent a known or pre-programmed gesture, in that values corresponding to that respective gesture are stored in the look-up table 810 prior to the user moving the electronic aerosol provision device 20. The data 840 stored in the look-up table 810 can be considered training data for training the AI system 480.

In some examples, the values stored in the look-up table 810 are obtained using a motion sensor and a filter configured in accordance with the motion sensor 465 and filter 470 of the electronic aerosol provision device 20. In some examples, the filter is provided by a separate computing platform (for example a platform having a greater processing power than the filter 470 of the electronic aerosol provision device 20). To obtain the data, a test electronic aerosol provision system (e.g. part of a data logging system including the electronic aerosol provision device 20 and the separate computing platform) can be moved in accordance with a gesture to be trained into the AI system 480 (i.e. a performance of a gesture). A motion sensor in the test electronic aerosol provision system can be used to measure the motion (for example it may generate data at a fixed frequency or sampling rate). The data corresponding to the measured motion is provided to the filter (e.g. via a communications interface if the filter is external, or via internal circuitry if the filter is part of the test electronic aerosol provision system). The filter is then used to extract features based on the data corresponding to the spatial motion of the test device (i.e. the measured motion).

In some examples, data 840 in the look-up table 810 corresponds to the features extracted by the test system after a single performance of a gesture. In other examples, the motion corresponding to the target gesture is performed multiple times (e.g. at least 3 individual performances) with the motion being measured each time and respective features extracted. In these examples, the values may correspond to an average of the features extracted by the test system in each of the individual performances for the same target gesture.

It will be appreciated that the filter used to generate the training data, may differ from the filter 470 of the electronic aerosol provision device 20, in that it may be configured to generate values for a larger number of features 830. The number of features 830 extracted may be larger at least because there is not a need to provide a prompt response to a user. The AI system 480 provided with the training data may identify which features are needed for the identification of gestures, and therefore, conversely, the filter 470 of the electronic aerosol provision device 20 can be configured to not extract features 471 that are not needed (i.e. do not significantly influence the selection of a gesture). By reducing the number of features to only those that need to be extracted and processed to identify the relevant gestures, the response time of the AI system 480 can be improved.

To provide accurate training data, each individual performance of each gesture is isolated from motion data occurring outside of the performance of the gesture. For example, if there is motion data for a 10 second period and the performance occurred between 2 and 5 seconds, then the motion data prior to 2 seconds and subsequent to 5 seconds may be discarded to isolate the individual performance of the gesture.

In some examples, isolation can be achieved by comparing motion data in any of the available measured degrees of freedom to motion thresholds, thereby allowing the beginning and end of the performance to be determined. For example, motion recorded by an accelerometer and/or a gyroscope can be used to isolate the performance of a gesture. Furthermore, in some examples, motion recorded by any possible combination of the degrees of freedom of the accelerometer and/or gyroscope is used to isolate the performance of a gesture.

In some examples, isolation can be achieved dependent on a condition (or multiple conditions) indicating the duration of the gesture. In other words the condition is used to set, or otherwise determine, the beginning and end of the performance. In some examples a button (or other actuator) may be pressed for the duration the performance of the gesture, or the button may be pressed at the beginning and end of the performance. In some examples a light (e.g. from an LED) or a vibration (e.g. from a haptic device) indicates the start and stop of the recording of an individual gesture. By isolating the gesture the filter can be used to extract features only from data pertaining to a gesture, rather than data associated with periods of non-motion or other motions that might otherwise skew the feature extraction. Hence features extracted from the isolated gesture more accurately relate to or represent the respective gesture.

In some examples, the data in the look-up table 810 comprises optimal or representative values of the features for known gestures that may be performed by the user. The optimal or representative values are obtained by extracting features from motion data relating to one or more performances of each respective gesture. In some examples, the optimal or representative values correspond to features extracted by the test system from data corresponding to an individual performance of a target gesture. In some examples, the optimal or representative values correspond to averages of respective features extracted by the test system from data corresponding to a plurality of individual performances for the same target gesture.

In these examples, the look-up table 810 can be used for direct comparison by the AI system 480 to features 471 extracted by the filter 470 during use of the electronic aerosol provision device 20. By direct comparison, it is meant that the AI system 480 compares the values in the look-up table with the features extracted by the filter 470 (e.g. features stored in a data structure in accordance with FIG. 7) and determines a most likely match from the known gestures. For example, the AI system 480 may determine which set of features corresponding to a known gesture in the look-up table are most similar to the extracted features 471. It will be appreciated that the AI system 480 can be configured to implement a wide range of statistical and computing structures, such as neural networks, support-vector machines, Bayesian classifiers, and machine learning systems, for establishing which known gesture (e.g. trained gestures) is most similar to the extracted features 471. In this way, the AI system 480 can identify or predict which of the trained gestures the user is attempting to input.

In some examples, the AI system 480 may determine or identify weights or biases associated with certain features. For example, the AI system 480 may identify that a close match between a value in the look-up table 810 and the value of a particular extracted feature indicates a high probability of a certain gesture (i.e. user input). Similarly, the AI system 480 may identify that a combination of two of more extracted features having specific values similar to respective values stored in the look-up table (e.g. ratios implicit in the combination are similar for the extracted features and stored values) may indicate a high probability of a certain gesture. It will be appreciated that by providing the AI system 480 with training data, the AI system 480 is able to identify its own correlations between feature values and gesture performance based on the training data, that can then be used to determine or identify which gesture is being performed by a user of an electronic aerosol provision device 20.

In some examples, the data in the look-up table 810 corresponds to values that are used in the generation of AI models, to which the extracted features are passed. For example each row of the look-up table may comprise a set of values that are used as inputs for a respective AI Model that is implemented by the AI system. The AI system comprises multiple AI models, with each AI model corresponding to a different user input (i.e. gesture) to the electronic aerosol provision device. By corresponding it is meant that each AI model is trained to identify a respective one of the different user inputs (i.e. known gestures) for the electronic aerosol provision device.

In these examples, the AI system is configured to provide the extracted features to each of the AI models to identify the different respective user inputs for the device. For example, each of the AI models may provide an output indicative of the likelihood or probability that the extracted features correspond to the respective AI model. The AI system 480 may then identify that a user has performed user input or gesture which is indicated to have been most likely. In some cases the AI system 480 may also be configured to identify that the user has not provided a correct gesture, if for example the output for each model indicates a probability that is below a threshold. In some examples, different thresholds may be used for outputs from different models. As discussed above, it will be appreciated that an electronic aerosol provision system may undergo movement, for example, when being carried in a pocket or bag. By implementing thresholds, such movement will be less likely to cause a gesture to be recognised by the AI system 480.

AI Models for implementation by the AI system 480 may include a wide range of statistical and computing structures, such as neural networks, support-vector machines, Bayesian classifiers, machine learning systems, and so on. For example, in some implementations, the AI model 480 is provided using the TensorFlow Lite platform, originally developed by Google, and subsequently released as an open source deep learning framework for on-device inference, see https://www.tensorflow.org/lite. Alternative platforms that might be used for AI model 480 include PyTorch, which was originally developed by Facebook and subsequently released as an open source machine learning library, see https://pytorch.org/, and/or the Microsoft Cognitive Toolkit (CNTK), which is an open source toolkit for distributed deep learning, see https://docs.microsoft.com/en-us/cognitive-toolkit/.

The gestures being trained into the AI system 480 for recognition are symbolic in nature. In other words, movement of the device by a user is not being used to provide a direct analogue of some physical parameter such as position, speed, etc (as might be used, for example, in the context of gaming). Rather, the user input is used to perform a selection (classification) from a discrete (finite) set of distinct possibilities, each possibility being associated with a respective gesture. The AI system 480 is trained to match particular examples of motion data 466 produced by user input (movement of the device) to corresponding gestures. It will be appreciated that the training phase 910 may be iterative in nature. For example, if the AI system 480 is having trouble discriminating between two different gestures, the set of gestures might be revised to modify or remove one of the troublesome gestures (or potentially to replace the removed gesture by another, more distinctive, gesture).

More generally, the system 10 may have various levels of configurability. For example, in some implementations, the AI model 480 may be finalised (fixed) without the ability to be changed. In this case, a user may be provided with the set of gestures to use, such as in a hard-copy instruction manual.

In some implementations updates may be provided by the supplier of the electronic aerosol provision device 20 to update the functionality of the AI system 480. In some implementations, the user may be able to replace or supplement the data used to train the AI system 480 (and any AI models) by performing the gesture (e.g. as part of a calibration phase). A filter 470 may be used to extract features, which are then used to provide values for use in identifying a gesture associated with the extracted features. The updated values may be personalised to the user in that they take account of how a user performs each of the gestures, thereby allowing for more accurate identification of the user's future gestures.

In some implementations, the user may be able to supplement the existing gestures by providing additional training data for new gestures to be recognised. In some of these cases, the AI System 480 may implement a new AI model for each new gesture. As such, the user may be able to add a newly created gesture to the existing set of gestures, or in some cases, create an entirely new set of gestures (which may be personalised to the user). Updating (e.g. by training new gestures) can be used to provide at least one of the following: enhanced recognition, support for additional modes of operation, and support for additional input symbols for local languages.

Depending upon the capabilities of the system 10, such changes to the AI model 480 may be performed on an external device, such as a smartphone or laptop, e.g. using communications interface 410. In such cases, the external device may acquire the existing AI System 480 and Filter 470 (whether from electronic aerosol provision device 20, or from some other appropriate source), update the system, and then reload the AI System, and optionally filter, back into the electronic aerosol provision device 20. It will be appreciated that the external device may have significantly improved processing capabilities such that the extraction of features from new motion data, and the training of the system based on those features may be improved by utilising the external device. Software may be provided or made available by the supplier of the electronic aerosol provision device 20 to facilitate and guide the user through such updating of the AI system 480.

As previously stated, in general the filter 470 and the AI system 480 run on the electronic aerosol provision device 20. For example, the filter 470 and AI system 480 can be implemented on the microcontroller 455 as shown in FIG. 4, which in effect acts as a computing device in the electronic aerosol provision device 20 for running the filter 470 and AI system 480.

However, it is also possible that the electronic aerosol provision device 20 might interact with some external device such as a smartphone or laptop (for example, using communications interface 410) to offload some or all of the processing relating to the identification of a gesture onto the external device (in which case the identified gesture 481 might be returned to the user via the external device, such as by using a laptop screen, additionally or instead of returning it to the user via the electronic aerosol provision device 20).

For example, the filter and/or the AI system 480 may be installed on an external system, such as a smartphone or laptop, e.g. using communications interface 410 (see FIG. 9 below) In these examples, the electronic aerosol provision device 20 can interact with said external device to offload some or all of the processing associated with the filter and/or the AI system 480 onto the external device. Said external system may have greater processing power such that the processing associated with the filter and/or the AI system 480 can be carried out in a shorter time (e.g. because the external device supplements the processing power of the electronic aerosol provision system). Therefore, offloading some or all of the processing may speed up the response time for identifying and acting on a user gesture.

In some examples, the electronic aerosol provision device 20 is configured such that when the electronic aerosol provision device 20 is in communication with the external device having the filter 470 and/or AI system 480, the electronic aerosol provision device 20 offloads some or all of the processing associated with the filter and/or the AI system 480 onto the external device; whereas when the electronic aerosol provision device 20 is not in communication with the external device having the AI system 480, the electronic aerosol provision device 20 carries out all of the processing associated with the filter 470 and/or the AI system 480. This enables the electronic aerosol provision device 20 to advantageously utilise the processing power of the external device, without preventing the filter 470 and/or the AI system 480 from being used when the external device is not in communication with the electronic aerosol provision device 20.

Alternatively, in some examples the filter and/or the AI system 480 is not installed on the electronic aerosol provision device 20, such that the electronic aerosol provision device 20 is not able to carry out processing associated with the filter and/or the AI system 480, but is instead reliant on an external device having the filter and/or the AI system 480 to carry out the processing associated with the filter and/or the AI system 480. This is advantageous in that the capabilities of the microcontroller 455 (e.g. processor speed and memory requirements) can be reduced in comparison to a microcontroller 455 that is configured to support the filter and/or AI system.

FIG. 9 provides a high-level schematic diagram of certain electrical components of the control unit of FIG. 2 and of an external device 910. FIG. 9 is substantially similar to FIG. 4 and as such the operation of the individual components is not discussed in detail. However, FIG. 9 differs from FIG. 4 in that the AI system 480 is implemented on an external device 910 instead of the AI system 480 being implemented on the microcontroller 45, and in that the microcontroller 455 is configured to forward the extracted features to the AI system 480 via the communication interface 410.

The external device is a device that is capable of carrying out any necessary processing relating to the identification of a gesture using the AI system 480 (e.g. it has memory and a processor capable of performing any required operations). In some examples, the external device 910 is a device such as a smartphone, laptop, other form of computer or other appliance.

The microcontroller 455 is configured to communicate with the external device 910 via the communications interface 410. Example communications interfaces 410 may provide wired and/or wireless communications. For example a communication interface 410 may be configured to perform wireless communications using (for example) Bluetooth and/or any other suitable wireless communications standard. It will be appreciated that the communication between the electronic aerosol provision device 20 and the external device 910 is two way, in that the microcontroller 455 is configured to both send and receive data from the external device 910. For example, the microcontroller 455 may send the extracted features 471 to the external device 910 having the AI system 480, and may receive an indication of the identified gesture 481 from the external device 910 having the AI system 480.

In accordance with the examples above, the example electronic aerosol provision device 20 of FIG. 9 is reliant on the external device 910 having the AI system 480 to carry out the processing associated with the AI system 480. As such capabilities of the microcontroller 455 (e.g. processor speed and memory requirements) can be reduced in comparison to a microcontroller 455 that is configured to support the AI system. For example given that the microcontroller 455 is not used to implement the AI system 480, the processor load is reduced.

Furthermore, by providing the filter 470 on the microcontroller 455 the amount of the data to be sent to the external device 910 is reduced. For example, as previously stated the extracted one or more features of the data sample 466 will have a reduced size (e.g. memory storage requirement) in comparison to the data samples 466 from which they were extracted by the filter 470. Therefore by first processing the motion data 466 to extract features before sending the extracted features 471 to the AI system 480, the amount of data to be sent via the communications interface 410 is reduced significantly. As such it may be considered that the extracted features have a data rate lower than the data rate of the data samples provided by the motion sensor. This can be particularly advantageous when the bandwidth available for transmission is limited and/or when there are competing uses for the same transmission channel.

In some example devices 20, the AI-based input mechanism may interact with or be supported by other elements of a user interface to support operation of the AI system 480. For example, the system may be configured to prompt the user for a user input in the form of a gesture. Similarly, the system may be configured to notify the user when a character input has been successfully identified. This prompting and/or confirmation may take various forms, such as audible output (e.g. a beep or such-like), haptic feedback using vibration of the system 10, and/or visual output such as provided by an LED lamp.

It will be appreciated that prompting/confirming user input, or a user indicating the start/end of such input, may facilitate the AI model recognising an input character (such as by helping with determining the start of a recognition window as per FIG. 6). Likewise, feedback from the device to a user may be helpful for confirming that the user input has been recognised as intended.

The use of motion sensor 465, filter 470 and AI system 480 to provide and recognise user input may be utilised in many different ways for system 10. The following examples are provided by way of illustration, without limitation-any given device may support none, one, some or all of these examples.

For some systems, the user input recognised by the AI system 480 may comprise a pass code or password, analogous to a personal identification number (PIN), to enable (authorise) operation of the device 20 (and/or complete system 10). For example, the pass code might comprise a sequence of gestures for recognition by the AI system 480; if this pass code is not entered, some functionality of the device 20 or overall system 10 might be locked or restricted, for example, the heater might not be activated to prevent vaping. For some systems, the user input recognised by the AI system 480 may be used to set one or more operating parameters for the system 10. In some cases this may involve entering both a gestures for an identifier of the parameter and a gesture for a value for the operating parameter of interest. For example, a system 10 may support multiple heating levels during vaping, and the AI system may be utilised to set a desired heating level, such as low, medium or high. Other examples of user input to an AI system may be to reset error conditions, to select a desired heating profile, to navigate menu structures, to control and perform data communications with an external device, such as a smartphone, and so on. It will also be appreciated that use of the motion sensor 465, the filter 470 and the AI system 480 as a user input may serve to complement (rather than necessarily replace) existing user input facilities. As an example of this, a mechanical on/off button might be provided which physically opens or closes a circuit link (having a physical break in a circuit for the off state may provide slightly greater protection, for example, against accidental activation of the system).

More generally, an electronic aerosol provision system as disclosed herein incorporates a motion sensor configured to provide data samples relating to motion of the device; a filter configured to extract features from the motion sensor data samples; and an AI system configured to receive the extracted features and to use them to identify different user inputs for the device. As described above, the system can comprise an external, separate computing device such as a smartphone or computer, that supports the AI system (as well as the filter in some examples). This system allows for an efficient approach to gesture recognition in which the extraction of features allows for a reduction in data to be processed by the AI system 480, thereby improving the responsiveness of the system. Additionally, the amount of data to be transmitted between components of the system (including in some examples an external device) can also be reduced due to the extraction of features by the filter 470.

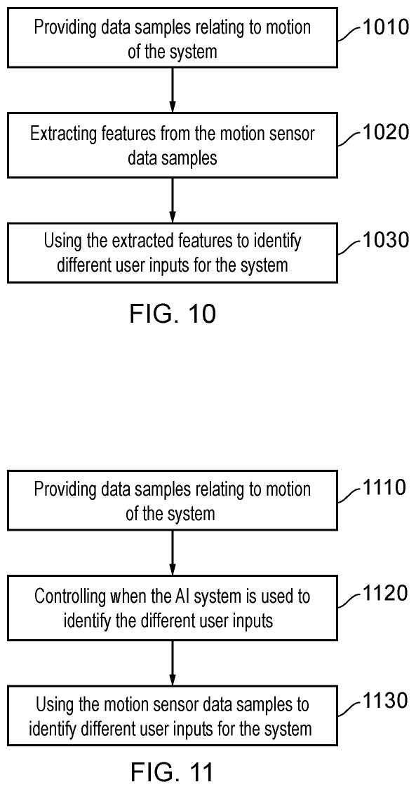

FIG. 10 is a schematic flowchart showing a process for identifying user inputs. The process is a method of operating an electronic aerosol provision system, said system comprising a motion sensor configured to provide data samples relating to motion of the system, a filter configured to extract features from the motion sensor data samples, and an artificial intelligence (AI) system. As noted above, in some examples, the motion sensor, filter and AI system may be provided in an electronic aerosol provision device 20; whereas in some examples the AI system, and in some cases the filter, is additionally, or alternatively supported by a separate external computing device.

The method starts at step 1010 in which the motion sensor provides data samples relating to motion of the system. The operation of the motion sensor is as described above with the motion sensor having measured, recorded, or otherwise obtained the data samples using one or more components configured to detect a spatial motion of the device. For example, as detailed above, the motion sensor can comprise an accelerometer, a gyroscope, and other components for detecting spatial motion of the device. Each component for detecting spatial motion may be configured to detect and record motion along multiple axes (e.g. mutually perpendicular x, y, z axes). The motion sensor is configured to provide the data samples to the filter; for example by inputting the data samples into the buffer accessible by the filter. When the filter is instead provided by an external computing device, the data samples may be provided (e.g. transmitted) via the communications interface.

The method continues at step 1020 with the filter extracting features from the motion sensor data samples. The features to be extracted comprise values of statistical or mathematical characteristics or relationships of the motion sensor data samples, such as means, medians, maximums, minimums, and correlations of portions of the motion sensor data samples. The extracted features are provided to the AI system, for examples by being stored in a memory accessible by the AI system. When the filter is provided by an electronic aerosol provision device, and the AI is provided by an external computing device, the features may be provided (e.g. transmitted) via the communications interface.

The method continues at step 1030 with the AI system using the extracted features to identify different user inputs for the system. The AI system may input the extracted features to one or more AI models to identify or predict the user's desired input (e.g. by selecting the input having the highest probability). As such, the AI system is configured to output an identified gesture for use by components of the system. For example, the identified user input can be used to control an aspect of the system such as the aerosol generator or a display. In this way, the process shown in FIG. 10 provides for a AI-supported user input facility.

FIG. 11 is a schematic flowchart showing a process for identifying user inputs. The process is a method of operating an electronic aerosol provision system, said system comprising a motion sensor configured to provide data samples relating to motion of the system, an artificial intelligence (AI) system configured to receive the data samples and to use them to identify different user inputs for the system, and a user input facility a user input facility configured to control when the AI system is used to identify the different user inputs. As noted above, in some examples, the motion sensor and AI system may be provided in an electronic aerosol provision device 20; whereas in some examples the AI system is additionally, or alternatively supported by a separate external computing device.

The method starts at step 1110 in which the motion sensor provides data samples relating to motion of the system. The operation of the motion sensor is as described above with the motion sensor having measured, recorded, or otherwise obtained the data samples using one or more components configured to detect a spatial motion of the device. For example, as detailed above, the motion sensor can comprise an accelerometer, a gyroscope, and other components for detecting spatial motion of the device. Each component for detecting spatial motion may be configured to detect and record motion along multiple axes (e.g. mutually perpendicular x, y, z axes). The motion sensor is configured to provide the data samples to the AI system; for example by inputting the data samples into the buffer accessible by the AI system. When the AI system is instead provided by an external computing device, the data samples may be provided (e.g. transmitted) via the communications interface. Furthermore, in some examples, the motion sensor provides the motion sensor data samples via a filter which filters the motion sensor data samples to extract features with the filter operating in accordance with the description above (e.g. as per step 1020). In these examples having a filter the motion sensor data samples can be considered to be in the form of extracted features.

The method continues at step 1120 with a user controlling when the AI system is used to identify the different user inputs via a user input facility. For example when the user interacts with the user input facility to control the device to activate the AI system (e.g. by pressing a button), the AI system is enabled (e.g. operated), such that it can process the motion sensor data samples, to identify a user input. Furthermore, when the user interacts with the user input facility to deactivate the AI system (e.g. by ceasing to press a button), the AI system is disabled, such that it cannot process the motion sensor data samples, to identify a user input. Hence the processor load and power load associated with the AI system can be reduced by only enabling the processor when a user controls the device to enable the AI system to identify user inputs.

The method continues at step 1130 with the AI system using the motion sensor data samples to identify different user inputs for the system. The AI system may input the motion sensor data samples to one or more AI models to identify or predict the user's desired input (e.g. by selecting the input having the highest probability). It will be appreciated that in some examples the motion sensor data samples will be filtered by a filter to extract features for use in identifying a user input (e.g. gesture). Hence, in these examples the AI system is configured to receive the motion sensor data samples in the form of extracted features. The AI system is configured to output an identified gesture for use by components of the system. For example, the identified user input can be used to control an aspect of the system such as the aerosol generator or a display. In this way, the process shown in FIG. 11 provides for a AI-supported user input facility.

The AI-supported user input facility described herein can be implemented in a wide range of devices, including a combustible aerosol provision system, a non-combustible aerosol provision system or an aerosol-free delivery system.

As described herein, embedding 3D gyroscope and accelerometer sensors (and/or other sensors for detecting movement) into an electronic aerosol provision system or device, e.g. onto a circuit board of such a device, allows for a compact machine learning model to be trained and deployed to recognise consumer gestures (based on the motion data from the 3D gyroscope and accelerometer sensors) to complement or even fully replace mechanical operations. Advantageously the use of a filter to generate features, as described herein, substantially reduces the amount of data to be processed by the AI system thereby allowing for faster processing and gesture identification by the AI system.

Thus there has been described an electronic aerosol provision system including: a motion sensor configured to provide data samples relating to motion within the system; a filter configured to extract features from the motion sensor data samples; and an artificial intelligence (AI) system configured to receive the extracted features and to use them to identify different user inputs for the system. The motion within the system may be motion of at least a part of the system, for example motion of the entire system if an electronic aerosol provision device itself contains the filter and AI system, or motion of the electronic aerosol provision device in a system comprising the electronic aerosol provision device and an external computing device in which the external computing device contains the filter and/or AI system.

There has also been described an electronic aerosol provision system including: a motion sensor configured to provide data samples relating to motion within the system; an artificial intelligence (AI) system configured to receive the data samples and to use them to identify different user inputs for the system; and a user input facility configured to control when the AI system is used to identify the different user inputs. The motion within the system may be motion of at least a part of the system, for example motion of the entire system if an electronic aerosol provision device itself contains the filter and AI system, or motion of the electronic aerosol provision device in a system comprising the electronic aerosol provision device and an external computing device in which the external computing device contains the filter and/or AI system.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

The invention claimed is:

1. An electronic aerosol provision system including:
a motion sensor configured to provide data samples relating to motion of at least a part of the electronic aerosol provision system;
a filter configured to extract features from the motion sensor data samples; and
an artificial intelligence (AI) system configured to receive the extracted features and to use them to identify different user inputs for the electronic aerosol provision system.

2. The electronic aerosol provision system of claim 1, wherein the data samples relating to motion of the electronic aerosol provision system provide a time series indicating at least one of the position, velocity and/or acceleration of the electronic aerosol provision system.

3. The electronic aerosol provision system of claim 1, wherein the filter is included as part of the output of the motion sensor, as part of the input of the AI system, and/or as an intermediate component between the motion sensor and the AI system.

4. The electronic aerosol provision system of claim 1, wherein the filter operates in the time and/or frequency domain.

5. The electronic aerosol provision system of claim 1, wherein each extracted feature of the extracted features comprises a value of a statistical or mathematical characteristic of the motion sensor data samples.

6. The electronic aerosol provision system of claim 1, wherein a buffer for storing the motion sensor data samples is maintained in a memory of the electronic aerosol provision system.

7. The electronic aerosol provision system of claim 6, wherein the motion sensor obtains the motion sensor data samples at a first data rate, wherein the motion sensor is configured to provide the motion sensor data samples by incrementally storing them in the buffer at the first data rate.

8. The electronic aerosol provision system of claim 7, wherein the filter is configured to extract features at a second data rate, the second data rate being lower than the first data rate.

9. The electronic aerosol provision system of claim 1, wherein a first set of one or more features is extracted from the motion sensor data samples in a first state of the electronic aerosol provision system and a second, different set of one or more features is extracted from the motion sensor data samples in a second state of the electronic aerosol provision system.

10. The electronic aerosol provision system of claim 9, wherein the first state corresponds to the electronic aerosol provision system being in a dormant state and the second state corresponds to the electronic aerosol provision system being in an active state.

11. The electronic aerosol provision system of claim 1, wherein the electronic aerosol provision system supports updating the features to be extracted from the data samples by reconfiguring the filter to modify and/or supplement the features.

12. The electronic aerosol provision system of claim 11, wherein the electronic aerosol provision system is configured to communicate with an external computing device to update the features.

13. The electronic aerosol provision system of claim 11, wherein the features may be updated to provide at least one of the following: enhanced recognition, support for additional modes of operation, support for additional input symbols for local languages.

14. The electronic aerosol provision system of claim 1, wherein the AI system comprises multiple AI models, each AI model corresponding to a different user input to the electronic aerosol provision system.

15. The electronic aerosol provision system of claim 14, wherein each AI model has been trained to identify a respective one of the different user inputs for the electronic aerosol provision system.

16. The electronic aerosol provision system of claim 15, wherein the AI system is configured to provide the extracted features to each of the AI models to identify the different respective user inputs for the electronic aerosol provision system.

17. The electronic aerosol provision system of claim 1, wherein the electronic aerosol provision system comprises an electronic aerosol provision device comprising the motion sensor, and, optionally, a controller configured to support the filter and/or the AI system.

18. The electronic aerosol provision system of claim 17, wherein the electronic aerosol provision system comprises an external computing device configured to support the filter and/or the AI system.

19. The electronic aerosol provision system of claim 17, wherein the electronic aerosol provision device comprises a control unit for use in the electronic aerosol provision system in conjunction with a cartridge containing an aerosol precursor.

20. A method of operating an electronic aerosol provision system, the method comprising:
obtaining data samples relating to motion of at least a part of the electronic aerosol provision system from a motion sensor;
filtering the data samples to extract features of the data samples; and
using an artificial intelligence (AI) system to identify different user inputs for the electronic aerosol provision system from the features.
